(19) United States
(12) Patent Application Publication
(10) Pub. No.: US 2007/0096646 A1
(43) Pub. Date: May 3, 2007

(54) Electroluminescent displays

(76) Inventors: Harold Lee Van Nice, Corvallis, OR (US); Sterling Chaffins, Albany, OR (US); Terry M. Lambright, Corvallis, OR (US); John A. Devos, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/262,552

(22) Filed: Oct. 28, 2005

(51) Int. Cl. H05B 33/00

(52) U.S. Cl. 313/509

(57) ABSTRACT

A method for forming a powder phosphor electroluminescent display includes forming a dielectric film on a plurality of sides of an uncoated phosphor layer, wherein the dielectric film is formed via a polymer multilayer process.

### BACKGROUND

The phenomenon of electroluminescence (EL) is a non-thermal conversion of electrical energy into luminous energy. There are two classes of EL devices, high field and injection. In the familiar light emitting diode (LED) devices, light is generated by electron-hole pair recombination near a pn junction. Commercial LEDs have been fabricated from inorganic materials like GaAs, but recently there has been significant progress with the development of organic LED devices (OLEDs).

The high field devices include devices in which light is generated by impact excitation of a light emitting center (called the activator) by high energy electrons in materials like ZnS:Mn. The electrons gain their high energy from a changing electric field, and thus, this type of EL is often called high field electroluminescence. In thin film electroluminescent (TFEL) devices, it is the behavior of the majority carriers (the electrons) that predominately determine the device physics. The central layer of TFEL devices is a film phosphor which emits light when a large enough electric field is applied across it. The field level used to excite the film phosphor is sufficiently high that even a slight imperfection in the thin film stack surrounding the film phosphor can create a short circuit, causing a destructive amount of energy to be dissipated as if the phosphor were directly connected to the electrodes.

In a powder electroluminescent device, a thin layer of phosphor powder emits light when a changing electrical field is applied across it. The luminance of the phosphor per measure of electrical field applied increases as the distance between the electrodes is reduced. Traditional powder EL devices frequently use expensive encapsulated phosphors or screen print or spray a plurality of current limiting or insulating layers on either side of the phosphor layer to form a reliable device structure. Traditional screen printed insulating layers often resulted in pinholes or other defects. Consequently, the screen was rotated and the insulating layer was re-printed to reduce likelihood of pinholes. While the multiple insulating layers of traditional screen printing methods are sufficiently thick to prevent short circuits caused by imperfections in the film, the thick structure of the multiple insulating layers often limit the voltage drop across the phosphor layer requiring high signal voltages to excite the phosphor layers, are brittle, have variable thicknesses, and cannot be controlled with regard to weight per unit area of phosphor to create a display with grayscale

### SUMMARY

An exemplary electroluminescent display includes a flexible or rigid substrate, a first conductive layer, a first dielectric layer disposed on the flexible or rigid substrate, a layer of uncoated phosphor disposed on the first dielectric layer, a second dielectric layer disposed on top of the uncoated phosphor, and a second conductive layer disposed on the second dielectric layer, wherein the first dielectric layer, the powder phosphor layer, and the second dielectric layer are formed by a polymer multilayer (PML) forming process.

In another exemplary embodiment, a method for forming an electroluminescent display includes forming a dielectric film on a plurality of sides of an uncoated phosphor layer, wherein the dielectric film is formed via a polymer multilayer process.

### BRIEF DESCRIPTION OF THE DRAWINGS

The accompanying drawings illustrate various embodiments of the present system and method and are a part of the specification. The illustrated embodiments are merely examples of the present system and method and do not limit the scope thereof.

FIG. 1 illustrates a side cross-sectional view of an electroluminescent display structure, according to one exemplary embodiment.

FIG. 2 illustrates an exploded perspective view of an electroluminescent display structure, according to one exemplary embodiment.

FIG. 3A is a simple block diagram illustrating the components of a polymer multi-layer system, according to one exemplary embodiment.

FIG. 3B is a simple block diagram illustrating the components of a linearly fed polymer multi-layer system, according to one exemplary embodiment.

FIG. 4 is a flow chart illustrating a method for forming an electroluminescent display, according to one exemplary embodiment.

FIG. 5 is a flow chart illustrating a method for depositing a polymer multilayer film, according to various exemplary embodiments.

FIG. 6 is a cross-sectional side view illustrating a vertically stacked multi-phosphor layer electroluminescent display, according to one exemplary embodiment.

FIG. 7 is an exploded perspective view illustrating the components of a multi-phosphor layer electroluminescent display, according to one exemplary embodiment.

Throughout the drawings, identical reference numbers designate similar, but not necessarily identical, elements.

### DETAILED DESCRIPTION

An exemplary system and method for forming an electroluminescent display with ultra-thin encapsulating dielectric films are disclosed herein. Specifically, the exemplary electroluminescent display includes a flexible or rigid substrate, one or more phosphor layers formed on the flexible or rigid substrate, and a plurality of insulating dielectric films separating the one or more phosphor layers. The plurality of insulating dielectric films is formed on the flexible or rigid substrate and the phosphor layers using polymer multilayer technology. Additionally, the present method facilitates the formation of an electroluminescent display having vertically stacked RGB pixels for increased image resolution. Embodiments and examples of the present exemplary systems and methods will be described in detail below.

Unless otherwise indicated, all numbers expressing quantities of ingredients, reaction conditions, and so forth used in the specification and claims are to be understood as being modified in all instances by the term “about” or “approximately.” Accordingly, unless indicated to the contrary, the numerical parameters set forth in the following specification and attached claims are approximations that may vary depending upon the desired properties sought to be obtained by the present disclosure.

As used herein, the terms “conductor”, “conducting”, or “conductive” are meant to be understood as any material which offers low resistance or opposition to the flow of electric current due to high mobility and high carrier concentration.

Further, the term “dielectric” shall be understood broadly as including any number of materials configured to be a non-conductor or poor-conductor of electricity.

Moreover, as used herein, the term “RGB display” shall be interpreted broadly to include any display that uses a combination of red, green, and blue color sources to produce every color displayed.

In the following description, for purposes of explanation, numerous specific details are set forth in order to provide a thorough understanding of the present system and method for forming an electroluminescent display with ultra-thin encapsulating dielectric films. It will be apparent, however, to one skilled in the art, that the present method may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

Exemplary Structure

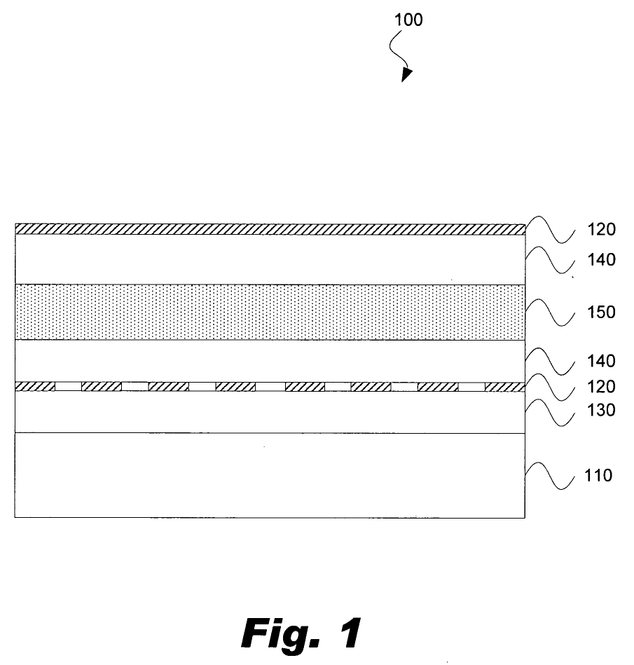

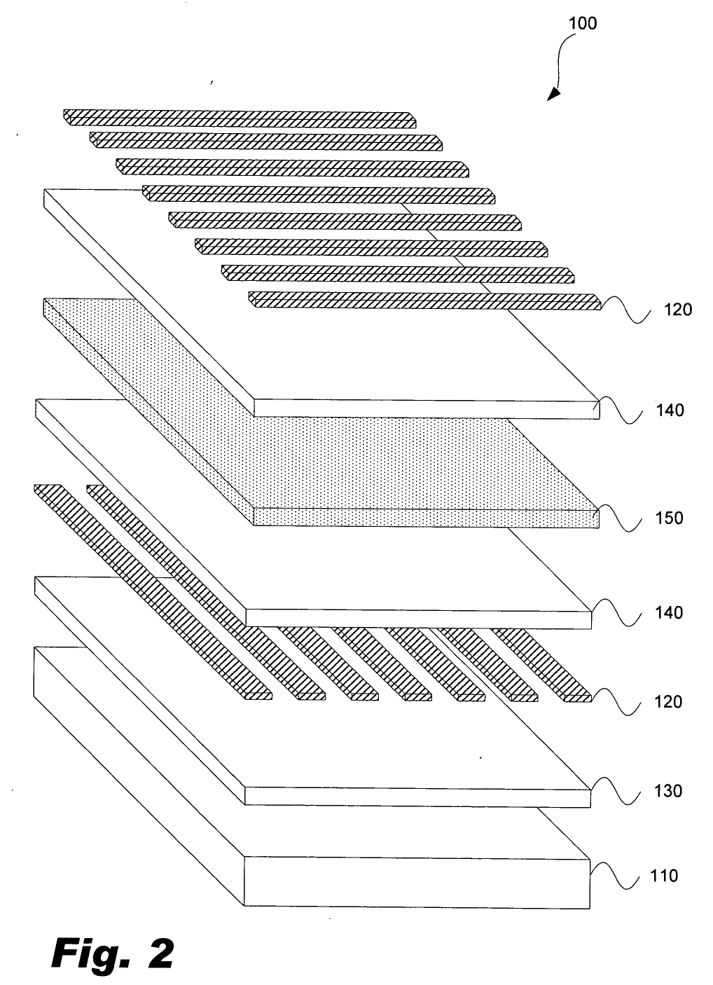

FIGS. 1 and 2 illustrate the individual components of an electroluminescent display (100) formed by polymer multilayer (PML) technology, according to one exemplary embodiment. As illustrated in FIGS. 1 and 2, the electroluminescent display (100) includes a phosphor layer (150) surrounded by a plurality of thin, dielectric layers that form a pinhole free dielectric layer (140) disposed on a flexible or rigid substrate (130). Additionally, a number of electrodes (120) are formed on the top and the bottom of the electroluminescent display stack (100). Further, according to the exemplary embodiment illustrated in FIGS. 1 and 2, the electroluminescent display stack (100) may be disposed on an optional structural substrate (110).

During operation of the exemplary electroluminescent display stack (100), a voltage is selectively supplied by a voltage source (not shown) to the electrodes (120). When the voltage is applied to the electrodes (120), an electric field is created, causing localized excitation of the phosphor layer (150), generating a localized emission of light.

As mentioned, the exemplary electroluminescent display stack (100) illustrated in FIGS. 1 and 2 includes an excitable illuminating phosphor layer (150). According to one exemplary embodiment, the excitable illuminating powder phosphor layer (150) is formed by phosphor particles distributed on a desired surface. More specifically, according to one exemplary embodiment, the phosphor particles are un-coated phosphor particles ranging from approximately sub-micron diameters to diameters of multiple microns. Alternatively, the un-coated phosphor particles may be of a single diameter or mono-disperse. Use of the relatively small phosphor particles allows for the transmission of light through the phosphor layer with little attenuation while providing higher excitation efficiency. As illustrated in FIGS. 1 and 2, the phosphor layer (150) is un-coated phosphor powder, and may be evenly distributed throughout one PML layer of the electroluminescent display. Powder phosphor eliminates the internal reflection problem of thin film EL display and luminance may be many times higher.

Additionally, according to one exemplary embodiment, the phosphor layer (150) may include any number of phosphor compositions and/or phosphors which give off different colors of light. In general, phosphors include a host material doped with an activator which is the light emission center. The classical yellow electroluminescent (EL) phosphor includes a zinc sulfide (ZnS) host lattice doped with Mn atom light emission centers. The ZnS and other phosphor host lattices typically have a band gap large enough to allow visible light to pass through without absorption. Consequently, appropriate phosphor excitation centers that may be incorporated in the present exemplary phosphor layer (150) include, but are not limited to, those excitation centers that facilitate production of light having a wavelength between approximately 400 and 700 nm. Consequently, II-VI materials, such as doped ZnS and SrS exhibit appropriate properties.

In addition to the classical yellow electroluminescent phosphor, the phosphor layer (150) may include any number of phosphors which give off other colors of light. According to one exemplary embodiment, the phosphor layer (150) may include phosphors configured to fluoresce in one of the primary red, green, or blue colors. According to this exemplary embodiment, acceptable red fluorescing phosphors included in the phosphor layer (150) may include, but are in no way limited to, ZnS:Mn phosphors, CaS:Eu phosphors, CaSSe:Eu phosphors, and ZnS:Sm phosphors, such as Y₂O₃:Bi³⁺,Eu³⁺; Sr₂P₂O₇:Eu²⁺,Mn²⁺; SrMgP₂O₇:Eu²⁺,Mn²⁺; (Y,Gd)(V,B)O₄:Eu³⁺; and 3.5MgO.0.5MgF₂.GeO₂: Mn⁴⁺ (magnesium fluorogermanate), in combination with any number of filtering means. Acceptable green fluorescing phosphors that may be included in the phosphor layer (150) of the electroluminescent display (100) may include, but are in no way limited to, terbium activated ZnS phosphors, ZnS:TbOF phosphors, ZnS:Mn phosphors, and/or SrS:Ce phosphors such as Ca₈Mg(SiO₄)₄Cl₂:Eu²⁺,Mn²⁺; GdBO₃:Ce³⁺, Tb³⁺; CeMgAl₁₁O₁₉: Tb³⁺; Y₂SiO₅:Ce³⁺,Tb³⁺; and BaMg₂Al₁₆O₂₇:Eu²⁺,Mn²⁺, in combination with any number of filtering means. Also, acceptable blue fluorescing phosphor include, but are in no way limited to, SrS:Ce, SrS:Ce co-doped with Ag(SrS:Ce,Ag), SrGa₂S₄:Ce, Ca₂GaS₄:Ce, SrS:Cu, SrS:Cu co-doped with Ag, and BaAl2S₄:Eu, BaMg₂Al₁₆O₂₇:Eu²⁺; Sr₅(PO₄)₁₀Cl₂:Eu²⁺; and (Ba,Ca,Sr)₅(PO₄)₁₀(Cl,F)₂:Eu²⁺, (Ca,Ba,Sr)(Al,Ga)₂S₄:Eu²⁺.

Alternatively, the phosphor layer (150) may include an efficient white (or broad band) phosphor that can be selectively filtered to produce an RGB display. More specifically, a color electroluminescent display may be produced by including a white phosphor layer. White EL phosphors that may be used to form the phosphor layer (150) include, but are in no way limited to, rare earth doped alkaline earth sulfides and stacked layers of SrS:Ce and ZnS:Mn.

As mentioned previously and illustrated in FIGS. 1 and 2, each side of the phosphor layer (150) is coated by a dielectric insulator layer (140). Traditional dielectric layers often suffer from cracking and breakdown when even a slight torsional load is applied thereto. Consequently, traditional powder phosphor layers are subject to oxygen and water vapor contamination that often results in a loss of display brightness, phosphor degradation, and display failure. Even pinhole imperfections in the dielectric layer of traditional electroluminescent displays may result in eventual display failure and electrical shorts.

In contrast to traditional displays, the phosphor layer (150) of the present exemplary electroluminescent display (100) is coated on each side by one or more thin dielectric insulator layers (140) formed by polymer multilayer (PML) processes which completely solves the oxygen and water vapor contamination of traditional dielectric layers. As will be described in further detail below, the process of coating PML dielectric insulator layers (140) on a desired phosphor layer (150) produces a flexible, pinhole free dielectric film that is relatively thin while providing extremely high barriers to oxygen and water vapor. Due to the relatively thin dielectric insulator layer (140), the electrodes are positioned relatively close, allowing for excitation of the phosphor layer (150) with a high electric field and possibly with very small current injection, increasing the luminance of the electroluminescent display. Additionally, the use of the PML process to form the phosphor layer (150) protects the phosphor from degradation due to hydrolysis, compared to traditional electroluminescent display fabrication methods using pre-coated expensive phosphor particles. Additionally, the use of the PML process allows the possibility of forming the electrodes directly on one side of the powder phosphor layer, according to one exemplary embodiment.

According to one exemplary embodiment, the dielectric insulating layer (140) may include any number of thin film dielectric coating materials including, but in no way limited to, alumina such as Al₂O₃, silica such as SiO₂, or other known metal oxides. According to one exemplary embodiment, the dielectric in the form of a metal oxide or the like is formed on the phosphor layer (150) by first distributing a number of monomers, initiating a polymerization of the monomers, applying the metal oxide to the polymerized layer and repeating the formation of alternating layers as desired.

Continuing with FIGS. 1 and 2, the phosphor layer (150), and the dielectric insulator layers (140) are formed on a flexible or rigid substrate (130). According to one exemplary embodiment, the flexible or rigid substrate (130) may exhibit any number of optical properties including, but in no way limited to, substantial transparency, reflectance, or any other optical characteristic that may be beneficial to the electroluminescent display (100). According to one exemplary embodiment, the flexible or rigid substrate layer (130) may be a single piece or a layered structure including a plurality of adjacent pieces of different materials. According to one exemplary embodiment, the flexible or rigid substrate layer (130) includes, but is in no way limited to a transparent rigid glass or polymeric flexible material such as polyethylenterephathalate (PET), polyacrylates, polycarbonates, silicone, epoxy resins, and/or silicone-functionalized epoxy resins.

FIGS. 1 and 2 also illustrate a number of opposing electrodes (120) disposed on either side of the phosphor layer (150). According to the exemplary illustrated embodiment, the opposing electrodes (120) are coupled to a power source (not shown) to allow selective activation of the electrodes. Consequently, the selective activation of the electrodes will allow for selective light generation on the electroluminescent display.

According to one exemplary embodiment, each phosphor layer (150) will be positioned between a cathode and an anode electrode. Materials suitable for use as an electrode include, but are in no way limited to, opaque or transparent conductive materials. Suitable opaque materials include, but are in no way limited to, K, Li, Na, Mg, La, Ce, Ca, Sr, Ba, Al, Ag, In, Sn, Zn, Zr, Sm, Eu, alloys thereof, or mixtures thereof. Layered non-alloy structures are also possible, such as a thin layer of a metal such as Ca (thickness from about 1 to about 10 nm) or a non-metal such as LiF, covered by a thicker layer of some other metal, such as aluminum or silver. An exemplary transparent conductor that may be used as an electrode includes, but is in no way limited to, indium tin oxide (ITO). According to one exemplary embodiment, one or more of the electrodes (120) is an anode injecting negative charge carriers (or electrons) into the insulator layer (140) and is made of a material having a high work function; e.g., greater than about 4.5 eV, preferably from about 5 eV to about 5.5 eV. Indium tin oxide (“ITO”) is typically used for this purpose. ITO is substantially transparent to visible light transmission and allows at least 80% of incident visible light to be transmitted there through. Consequently, light emitted from lower phosphor layers (150) can easily escape through the ITO anode layer without being seriously attenuated. Other materials suitable for use as the anode layer include, without limitation, tin oxide, indium oxide, zinc oxide, indium zinc oxide, cadmium tin oxide, and mixtures thereof. In addition, materials used for the anode may be doped with aluminum or fluorine to improve charge injection property. The electrode layers (120) may be deposited on the electroluminescent display (100) by physical vapor deposition, chemical vapor deposition, ion beam-assisted deposition, or sputtering. A thin, substantially transparent layer of metal is also suitable.

Additionally, according to one exemplary embodiment, the exemplary electroluminescent display (100) is coupled to an optional non-flexible structural substrate (110) either during or after fabrication. The non-flexible structural substrate (110) may include any number of materials including, but in no way limited to, glass, metal, silicon, or polymers. According to the illustrated exemplary embodiment, the non-flexible structural substrate (110) may be incorporated to prevent bending of the exemplary electroluminescent display (100) for stationary implementations.

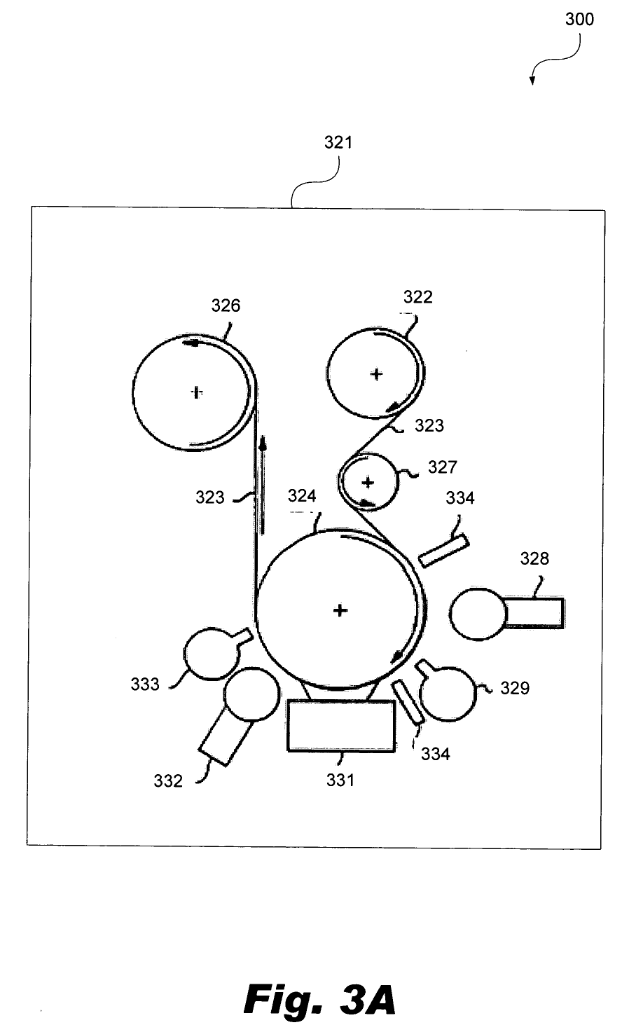

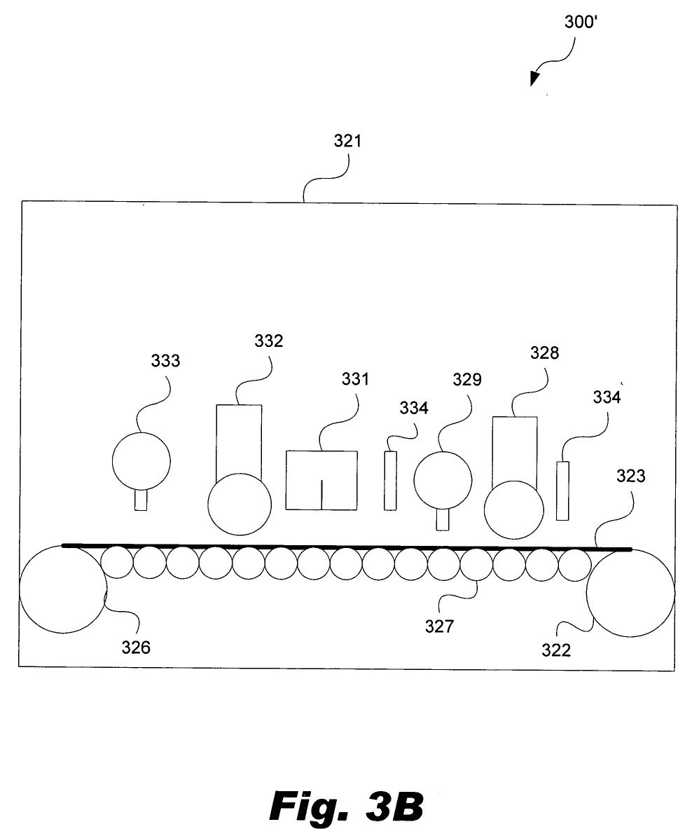

In one exemplary embodiment, a suitable apparatus for coating the substrate with conductive and barrier layers is illustrated schematically in FIG. 3A. As illustrated in the polymer multilayer system (300) of FIG. 3A, all of the coating equipment is positioned in a vacuum chamber (321). A roll of polypropylene, polyester, or other suitable plastic sheet is mounted on a pay-out reel (322). The plastic sheet forming the substrate (323) is wrapped around a first rotatable drum (324), and fed to a take-up reel (326). An idler roll (327) is also employed, as appropriate, for guiding the flexible plastic sheet material (327) from the payout reel (322) to the drum (324) and/or to the take-up reel (326).

It is often desirable to plasma treat the substrate (323) or other surface to be coated immediately before coating. Consequently, as illustrated in FIG. 3A, a number of conventional plasma guns (334) are positioned in the vacuum chamber upstream from each of the flash evaporators (328 and 332) for activating the surface of the substrate (323) on a continuous basis before monomer deposition. According to one exemplary embodiment, conventional plasma generators may be used. In an exemplary embodiment the plasma generator is operated at a voltage of about 500 to 1000 volts with a frequency of about 50 Khz. Power levels are in the order of 500 to 3000 watts. For an exemplary 50 cm wide film traveling at a rate of 30 to 90 meters per minute, around 500 watts may be appropriate. Plasma treatment of the substrate (323) enhances adhesion of subsequently deposited materials by making the treated surface highly wettable.

Additionally, as illustrated in FIG. 3A, a flash evaporator (328) is mounted in proximity to the first rotatable drum (324) at a first coating station. The flash evaporator (328) is configured to deposit a layer or film of monomer, typically an acrylate or a vinyl type monomer, on the substrate (323) as it travels around the drum (324). After being coated with a monomer, the substrate (323) passes an irradiation station where the monomer is irradiated by a radiation source (329) such as an electron gun or a source of ultraviolet radiation. The radiation or electron bombardment of the liquid monomer induces polymerization of the monomer previously deposited by the flash evaporator (328).

If desired, the freshly polymerized layer may be surface treated by plasma from the plasma gun (334). The substrate (323) then passes a deposition station (331) where a desired metal oxide coating may be applied by plasma deposition, vacuum deposition, or the like. The substrate (323) then passes another flash evaporator (332) where another monomer layer may be deposited. This second layer of liquid monomer may then be cured by irradiation from an ultraviolet or electron beam source (333) adjacent the first rotatable drum (324). The coated substrate (323) is then wrapped on the take-up reel (326) for further processing.

While, the above-mentioned exemplary PML system (300) is described in the context of incorporating monomers that may polymerize through the application of ultraviolet radiation, the polymerization of the monomers may also be induced by exposure to plasma. Alternatively, polymerization of the monomers may be accomplished by passing the monomer gas through a glow discharge zone, under forced flow conditions, prior to condensation on the substrate. According to this exemplary embodiment, the vapor plasma immediately begins to polymerize to form a solid film due to the high concentration of radicals and ions contained in the resulting liquid film.

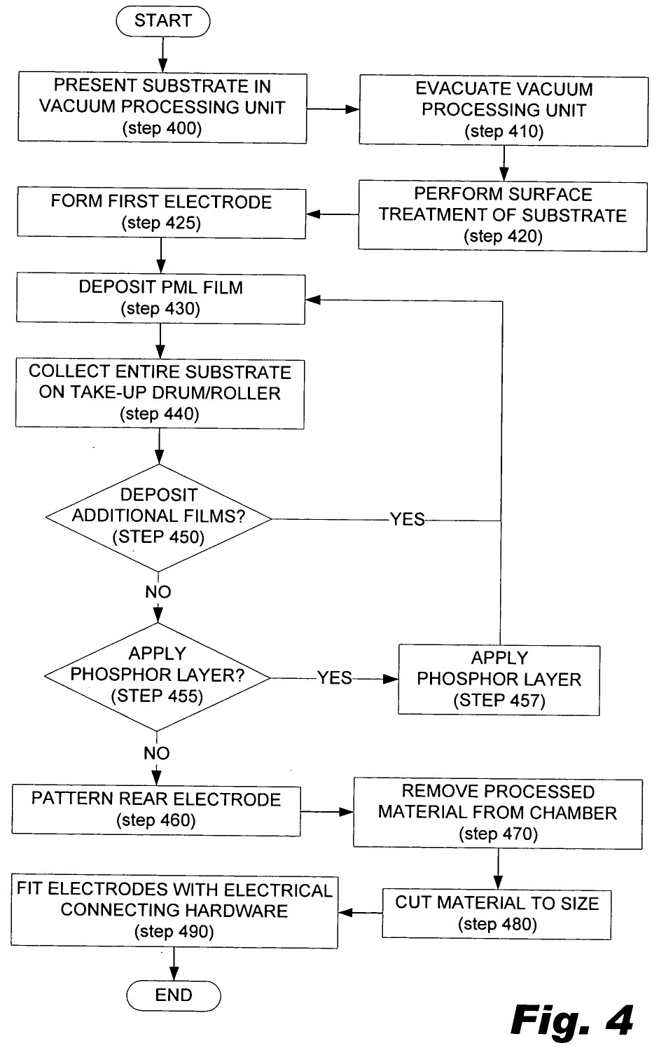

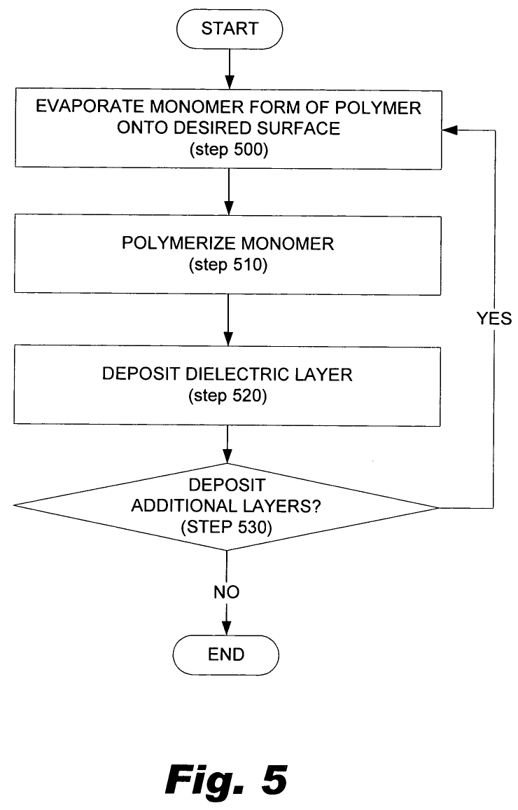

Further, while the exemplary PML system (300) illustrated in FIG. 3A is oriented in a curved PML roller configuration that is more conducive to a flexible substrate, any number of linear or near linear configurations may also be incorporated to facilitate deposition onto a rigid substrate. FIG. 3B illustrates an alternative PML system configuration (300′), according to one exemplary embodiment. As illustrated in FIG. 3B, a box-coater configuration may be employed to simulate the PML deposition process onto a rigid substrate. As illustrated in FIG. 3B, a rectangular vacuum chamber (321) contains a feed (322) and take up roller (326) positioned on each end of a number of idler rollers (327). This configuration provides an exemplary transport system for a substrate (323). Additionally, a number of deposition components such as plasma guns (334), a number of flash evaporators (328, 332), a number of radiation sources (329, 333), and a deposition station (331) are disposed adjacent to the path of the desired substrate to perform the PML deposition process. According to the embodiment illustrated in FIG. 3B, a rigid or a flexible substrate may be fed across the idler rollers (327) to receive a number of desired layers. Exemplary formation methods incorporating the exemplary PML systems (300, 300′) will now be described in detail with reference to FIGS. 4 and 5.

Exemplary Formation

FIG. 4 illustrates an exemplary method for forming an electroluminescent display stack using the PML apparatus of FIGS. 3A and 3B, according to one exemplary embodiment. As illustrated in FIG. 4, the exemplary method begins by first spooling a flexible substrate on a take-up drum (step 400). Alternatively, a rigid substrate may be presented to the take up roller (326). Once the substrate is presented in the vacuum chamber, the vacuum processing unit may be evacuated (step 410). Then, a surface treatment may be performed on the substrate (step 420) to enhance adhesion and wettability of subsequently deposited materials. With the surface of the desired substrate appropriately treated (step 420), a first electrode may be formed (step 425) and a desired PML film may then be deposited thereon (step 430) according to any number of deposition methods. With the desired PML layer deposited on the substrate, the entire substrate may be rolled on a take-up drum or collected by a take-up roller (step 440). Once collected, the substrate may be further processed. According to the illustrated exemplary method, it is determined if an additional PML film is to be deposited (step 450). If another film is to be deposited (YES, step 450), another PML film is deposited (step 430) and the flexible or rigid substrate is again collected by the take-up drum or roller (step 440). If, however, additional films are not to be deposited on the substrate (NO, step 450), it is determined whether a phosphor layer is to be deposited (step 455). If a phosphor layer is to be deposited (YES, step 455), the phosphor is applied to the surface of the PML layer (step 457), and another PML film layer is deposited (step 430). This process continues until the desired layers of phosphor and PML have been formed and no further layers are desired (NO, step 455). With all the desired phosphor layers and PML layers formed, any subsequently desired electrodes may be patterned on the display stack (step 460) and the processed material may be removed from the vacuum chamber (step 470). Once the processed material is removed from the chamber (step 470), it may be subsequently processed by being cut to a desired size (step 480) and receiving electrical connecting hardware on the formed electrodes (step 490). Further details of the above-mentioned method will be provided below.

As mentioned, the first step of the exemplary method includes presenting a desired substrate in a vacuum processing unit or chamber (step 400). For a flexible substrate, the substrate may be spooled on the take-up drum of the PML system. According to one exemplary embodiment, a flexible or rigid substrate (323; FIG. 3A) up to several feet wide and up to several thousand feet long may be spooled and placed in the PML vacuum processing unit (300; FIG. 3A) threading through several processing stations and onto a take-up reel (326; FIG. 3A). Alternatively, a rigid substrate may be presented to a feed roller.

With the desired substrate properly situated in the PML system (step 400), the vacuum processing unit may be evacuated (step 410). As used herein, the term evacuation is meant to be understood broadly as removing a substantial quantity of gas and/or potential contaminates from the processing environment, and not necessarily producing a space completely devoid of gas or other matter. Creating the vacuum in the processing unit (step 410) provides a reduction in possible contaminates while enhancing the wetting characteristics of the polymeric pre-cursors.

Upon evacuation (step 410), the substrate is moved through the process stations at up to 1000 feet per minute or more to receive desired films. According to the exemplary method illustrated in FIG. 4, the flexible or rigid substrate receives a surface treatment (step 420) prior to receiving a desired film. According to one exemplary embodiment, the plasma gun (334; FIG. 3A) bombards the surface of the substrate with plasma or ions to clean the surface of the substrate, thereby enhancing the adhesion and wettability of subsequently formed films.

With the surface of the substrate (323; FIGS. 3A and 3B) sufficiently treated, the present exemplary method continues by forming a first electrode (step 425) with any number of known thin film deposition methods, and then depositing a desired polymer multilayer (PML) film on the substrate and first electrode (step 430). According to one exemplary embodiment, the material deposited on the substrate is a monomer that can be polymerized.

FIG. 5 illustrates one exemplary method for depositing the PML film (step 430), according to one exemplary embodiment. As illustrated in FIG. 5, the PML film is formed on the substrate (323; FIGS. 3A, 3B) by first evaporating a monomer form of a desired polymer onto the desired surface (step 500) and then polymerizing the monomer (step 510) to form the polymerized layer. As mentioned previously, according to one exemplary embodiment, the evaporation of a monomer form of a desired polymer on to the desired surface (step 500) may be performed by a flash evaporator (328; FIGS. 3A, 3B). Once deposited, the monomer may then be polymerized by exposure to a radiation source (329; FIGS. 3A, 3B). According to the present exemplary embodiment, the monomeric form of the desired polymer is evaporated at a rate appropriate to cause the desired film thickness. Since the monomeric material may be in a liquid form and the surface of the flexible or rigid substrate (323; FIGS. 3A, 3B) has received a surface treatment to clean and provide a high surface energy, the liquid monomer uniformly wets the substrate surface without pinholes. The uniform thickness coating of the liquid monomer onto the substrate (323; FIGS. 3A, 3B) or other substrate causes planarization of the surface. Consequently, films of desired physical, chemical, mechanical, and electrical characteristics are invariably produced.

According to one exemplary embodiment, the monomeric form of the desired polymer is evaporated onto the surface of the substrate (323; FIGS. 3A, 3B). Evaporation of the monomer is preferably from flash evaporation apparatus (328, 332; FIGS. 3A, 3B) as described in U.S. Pat. Nos. 4,722,515, 4,696,719, 4,842,893, 4,954,371 and/or 5,097,800. According to one exemplary embodiment, the flash evaporation apparatuses (328, 332; FIGS. 3A, 3B) operate by injecting a liquid monomer into a heated chamber as 1 to 50 micrometer droplets. The elevated temperature of the chamber vaporizes the droplets to produce a monomer vapor. The monomer vapor fills a generally cylindrical chamber with a longitudinal slot forming a nozzle through which the monomer vapor flows. A typical chamber behind the nozzle is a cylinder about 10 centimeters diameter with a length corresponding to the width of the substrate on which the monomer is condensed. The walls of the chamber may be maintained at a temperature in the order of 200° to 320° C.

In an alternative embodiment, a liquid PML (called Liquid Multilayer, LML) smoothing applicator (not shown) may be mounted in proximity to the first rotating drum (324; FIGS. 3A, 3B) at a first coating station. The liquid smoothing applicator (not shown) may deposit a layer of monomer, e.g. acrylate, over the flexible or rigid substrate (323; FIGS. 3A, 3B). This layer of monomer may then be cured by irradiation from an ultraviolet or electron beam source or plasma, as mentioned previously.

Once the desired monomer is polymerized (step 510), a dielectric layer may be formed thereon (step 520). According to one exemplary embodiment, the dielectric layer may be deposited by any number of thin film deposition methods including, but in no way limited to, evaporation, sputtering, electron beam evaporation, molecular beam epitaxy, etc. With the dielectric layer formed (step 520), it is determined if further layers are to be deposited (step 530). If further layers are to be deposited (YES, step 530), the PML deposition process may be repeated. If however, no further PML layers are to be deposited, the PML process is complete for the desired layers.

Returning again to FIG. 4, once the desired layers are formed on the flexible or rigid substrate (323; FIGS. 3A, 3B), the entire roll of product is collected by either the take-up drum or take-up roller (step 440). With a first PML layer formed on the flexible or rigid substrate, it is determined whether additional films are to be deposited on the substrate (step 450). As illustrated in the electroluminescent display stack of FIG. 1, a number of layers may be formed on the flexible or rigid substrate (130; FIG. 1). If additional films are to be deposited (YES, step 450), the coated substrate is run back through the PML processing system (300; FIG. 3A, 300′; FIG. 3B) to deposit further films. According to the present exemplary embodiment, the additional film may be, but is in no way limited to, a polymeric film, a dielectric film such as silicon dioxide, silicon nitride, aluminum oxide, or a wide range of metals or clear conductors. Any material which can be processed by evaporation, sputtering, electron beam evaporation, molecular beam epitaxy, etc. can be interspersed with polymeric films to build up hundreds of layers for a device structure. For example, according to one exemplary embodiment, one of the backside layers formed on the substrate may be a reflective metal configured to enhance brightness of the resulting electroluminescent display stack.

Once it is determined that sufficient polymeric layers have been formed on the substrate (323; FIGS. 3A, 3B) to protect a phosphor layer, the first layer of phosphor powder is applied (YES, step 455). According to the present exemplary system and method, the phosphor powder layer (150; FIG. 1) of the electroluminescent display stack (100; FIG. 1) may applied either in the vacuum chamber (321; FIGS. 3A, 3B) or alternatively, the coated flexible or rigid substrate may be removed from the vacuum chamber (321; FIGS. 3A, 3B) and the phosphor applied. According to one exemplary embodiment, the phosphor powder layer (150; FIG. 1) may be mono-disperse or formed of various phosphor sizes less than approximately 30 microns in diameter. Additionally, according to one exemplary embodiment, the surface to receive the phosphor powder is charged and the phosphor powder is electrographically dispersed on the desired surface. Alternatively, any number of mechanical dispersion methods may be used to deposit the phosphor powder on the desired substrate.

Once the first layer of phosphor is applied to the flexible or rigid substrate (step 457), additional layers of PML film may be applied (step 430) to the phosphor to form a hermetic seal. The subsequent PML films formed on the phosphor layer may include, but are in no way limited to, additional layers of dielectric and clear conductive films. According to one exemplary embodiment, the additional films are formed on the phosphor to provide the second half of an electroluminescent display stack, thereby providing protection to the phosphor layer from oxygen and water vapor. Additionally, the PML film forms a planarized layer on top of the rough phosphor particles, which aids in display quality and ease of formation.

Once no further film layers (NO, step 450) or phosphor layers (NO, step 455) are desired, a rear electrode may be patterned on the electroluminescent display stack (step 460), according to one exemplary embodiment. More particularly, according to one exemplary embodiment, a rear electrode may be patterned to provide electrically separate areas of the resulting electroluminescent display. Similarly, according to one alternative embodiment, if multiple layers of phosphors are formed between the various PML film layers, independently addressable front and rear electrodes may be formed between the various phosphor layers, providing electrically separate areas in each layer of phosphor. Further, according to one exemplary embodiment, the various electrodes may be interdigitated. Formation of the various electrodes may be accomplished using any number of thin film forming techniques including, but in no way limited to, sputter deposition, evaporative deposition. Additionally, as mentioned previously, the electrodes may be formed of any number of materials including, but in no way limited to, metals, organic materials, and/or inorganic materials.

With the desired electrodes patterned, the roll of processed material may be removed from the vacuum chamber (step 470). Once removed, the large roll of processed material may then be cut to desired sizes (step 480) and the electrodes may then be fitted with electrical connecting hardware (step 490), thereby finishing the formation of a desired electroluminescent display.

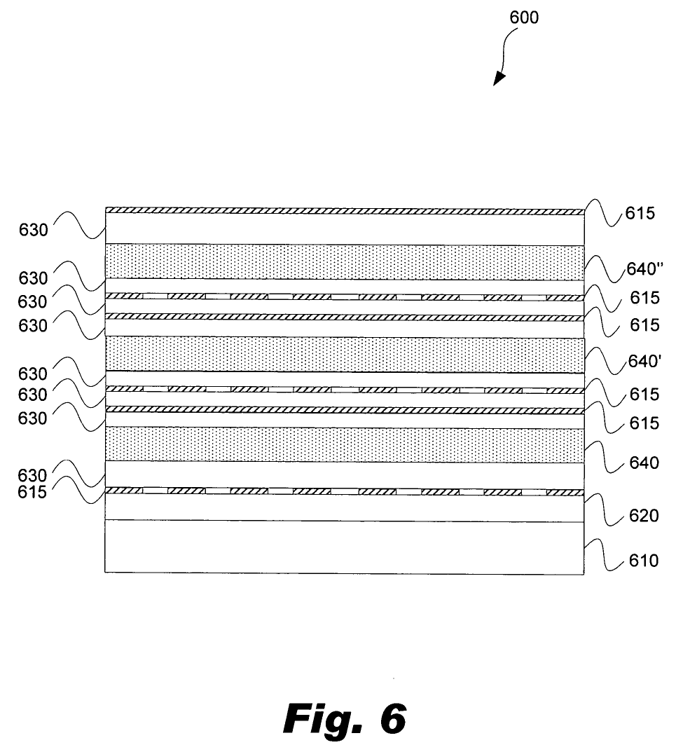

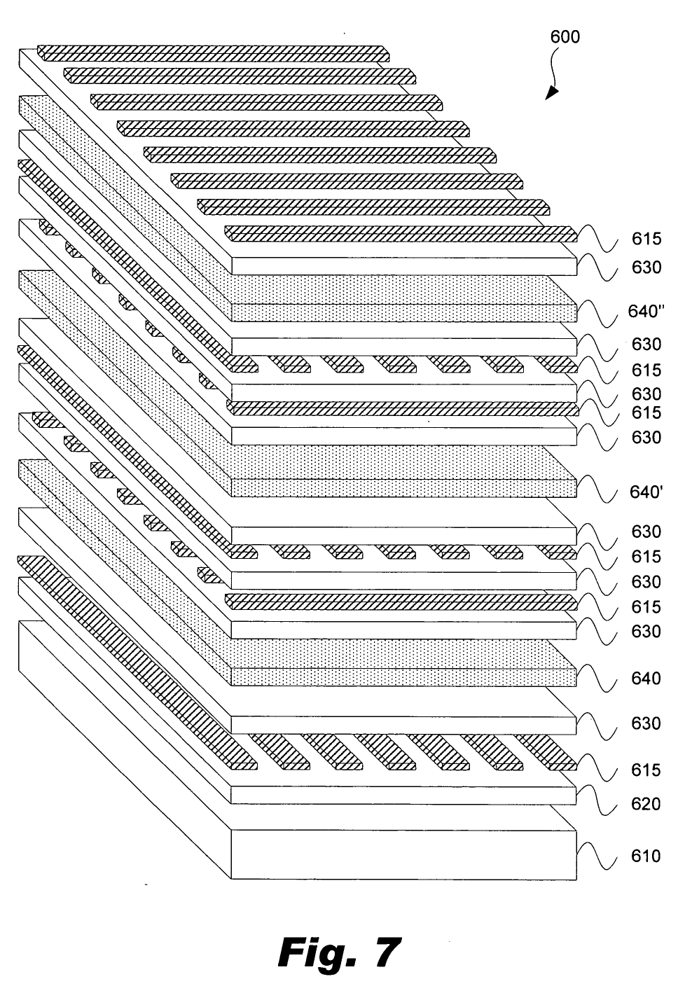

As mentioned above, the present exemplary method illustrated in FIG. 4 can be used to form a plurality of hermetically sealed phosphor layers, between PML films. According to one exemplary embodiment, each separate phosphor layer may be a material emitting a different color light. Consequently, according to one exemplary embodiment, multiple combination layers composed of a phosphor powder layer, a dielectric, and a clear conductive layer can be built up to form an EL display radiating layer structure. According to one exemplary embodiment, the various phosphor layers may contain red, green, and blue light emitting phosphor with controlled weight per unit area of each type, to form a three color display with grayscale, as illustrated in further detail in FIGS. 6 and 7. While the present exemplary EL display having stacked phosphor layers of varying color is presented in the context of a red, a green, and a blue light emitting layer, for ease of explanation only, any number of differing color schemes may be used to provide a desired effect.

As illustrated in FIGS. 6 and 7, the above-mentioned method may be used to form a vertically stacked RGB electroluminescent display, according to one exemplary embodiment. As illustrated in FIGS. 6 and 7, a vertically stacked RGB electroluminescent display (600) includes a first phosphor layer (640), a second phosphor layer (640′), and a third phosphor layer (640″) separated by a number of electrodes (615) and dielectric layers (630). According to one exemplary embodiment, the first phosphor layer (640), the second phosphor layer (640′), and the third phosphor layer (640″) each illuminate in different portions of the visible light spectrum. More specifically, according to one exemplary embodiment, one of the phosphor layers may be configured to illuminate in the red portion of the visible spectrum when excited, a second phosphor layer may be configured to illuminate in the green portion of the visible spectrum when excited, and a third phosphor layer may be configured to illuminate in the blue portion of the visible spectrum when excited. Consequently, the resulting vertically stacked RGB electroluminescent display (600) may produce independently addressable, vertically stacked RGB pixels. According to this exemplary embodiment, the resolution of the display will be nine times that of comparable side by side pixilated displays.

As shown, the vertically stacked RGB electroluminescent display (600) is formed on a flexible or rigid substrate (620), and may be placed on another optional structural substrate (610). According to the exemplary embodiment illustrated in FIGS. 6 and 7, each phosphor layer (640, 640′, and 640″) is bordered on each side by a PML dielectric layer (630) and a number of addressable electrodes (615). According to this exemplary embodiment, by forming each phosphor layer (640, 640′, and 640″) between a number of flexible PML dielectric layers (630), an active display is produced having increased resolution and decreased display fabrication costs.

According to one exemplary embodiment of the vertically stacked RGB electroluminescent display (600), at least one of the addressable electrodes (615) is transparent and at least one of the addressable electrodes is opaque. According to this exemplary embodiment, the very bottom addressable electrode (615) is opaque while the remaining electrodes are transparent. This allows light generated by lower layers of phosphor emitting various colors to be seen by a viewer. In an alternative embodiment, the various addressable electrodes (615) may be patterned to avoid interference between light being emitted from the various layers of phosphor. Similarly, the phosphor powders may be continuous or patterned, according to various embodiments.

Additionally, according to one exemplary embodiment, the bottom electrode may be made of a reflective material such as aluminum. According to this exemplary embodiment, the incorporation of a reflective rear electrode will cause light generated by the phosphor layers to be reflected out the front of the display, resulting in increased luminance of the display.

In conclusion, the present exemplary system and method for forming electroluminescent displays via PML processing allows for the manufacture of large area, flexible, pinhole free dielectric films at very low cost on very large area substrates. The present exemplary system and method provides extremely high barrier to oxygen and water vapor, while reducing manufacturing costs. Further the present exemplary system and method allows use of non-encapsulated phosphor. Use of a thin dielectric coating allows the electrodes to be disposed relatively close to one another, allowing very small current injections during excitation of the phosphor to significantly increase the luminance of an EL display. Consequently, higher luminance and resolution displays manufactured at reduced costs result. Further, the layers produced by the PML process have uniform thickness for ease of manufacturing and display quality.

The preceding description has been presented only to illustrate and describe exemplary embodiments of the present system and method. It is not intended to be exhaustive or to limit the system and method to any precise form disclosed. Many modifications and variations are possible in light of the above teaching. It is intended that the scope of the system and method be defined by the following claims.

What is claimed is:

1. An electroluminescent display comprising:
a substrate;
a first conductive electrode disposed on said substrate;
a first dielectric layer disposed on said first conductive electrode;
a layer of uncoated phosphor disposed on said first dielectric layer;
a second dielectric layer disposed on top of said uncoated phosphor; and
a second conductive electrode formed on said second dielectric layer;
wherein said first dielectric layer and said second dielectric layer are formed by a polymer multilayer (PML) forming process.

2. The electroluminescent display of claim 1, wherein said first and said second dielectric layers comprise pinhole free dielectric layers formed by a PML forming technique.

3. The electroluminescent display of claim 1, wherein said uncoated phosphor comprises a plurality of uncoated phosphor particles having a maximum diameter less than approximately 30 microns.

4. The electroluminescent display of claim 1, wherein said uncoated phosphor particles comprise ZnS host lattice doped with Mn atom light emission centers.

5. The electroluminescent display of claim 1, wherein said uncoated phosphor particles comprise one of a red electroluminescent phosphor, a green electroluminescent phosphor, a blue electroluminescent phosphor, or a white electroluminescent phosphor.

6. The electroluminescent display of claim 1, wherein said substrate is transparent.

7. The electroluminescent display of claim 1, further comprising at least one electrode formed on each of said first dielectric and said second dielectric.

8. The electroluminescent display of claim 7, wherein said electrodes are interdigitated.

9. The electroluminescent display of claim 7, wherein at least one of said electrodes comprise a transparent electrode.

10. The electroluminescent display of claim 9, wherein said transparent electrode comprises Indium Tin Oxide.

11. The electroluminescent display of claim 7, wherein at least one of said electrodes comprise a reflective electrode.

12. The electroluminescent display of claim 1, wherein said first dielectric layer and said second dielectric layer are formed via a flash evaporation of a liquid containing dielectric material.

13. The electroluminescent display of claim 1, wherein said substrate comprises a flexible substrate.

14. The electroluminescent display of claim 1, wherein said substrate comprises a rigid substrate.

15. The electroluminescent display of claim 1, further comprising:
a first layer of uncoated phosphor disposed between a first plurality of dielectric layers; and
a second layer of uncoated phosphor disposed between a second plurality of dielectric layers;
wherein said first layer of uncoated phosphor and said second layer of uncoated phosphor are disposed in a single stack.

16. The electroluminescent display of claim 15, wherein said first layer of uncoated phosphor is configured to generate light having a first wavelength when excited; and
wherein said second layer of uncoated phosphor is configured to generate light having a second wavelength when excited.

17. The electroluminescent display of claim 15, further comprising a plurality of independently addressable electrodes formed on each of said dielectric layers.

18. The electroluminescent display of claim 15, further comprising:
a layer of uncoated red light emitting electroluminescent phosphor disposed between a first plurality of dielectric layers;
a layer of uncoated green light emitting electroluminescent phosphor disposed between a second plurality of dielectric layers;
a layer of uncoated blue light emitting electroluminescent phosphor disposed between a third plurality of dielectric layers; and
a plurality of independently addressable electrodes formed on each of said first plurality of dielectric layers, said second plurality of dielectric layers, and said third plurality of dielectric layers;
wherein said layer of uncoated red light emitting electroluminescent phosphor, said layer of green light emitting electroluminescent phosphor, and said layer of blue light emitting electroluminescent phosphor are vertically stacked to form a red/green/blue display.

19. The electroluminescent display of claim 18, wherein:
at least two of said first plurality of dielectric layers, said second plurality of dielectric layers, and said third plurality of dielectric layers are optically transparent; and
wherein said plurality of said electrodes include one layer of reflective electrodes and a plurality of layers of optically transparent electrodes.

20. A method for forming an electroluminescent display comprising forming a dielectric film on a plurality of sides of an uncoated phosphor layer;
wherein said dielectric film is formed via a polymer multilayer process.

21. The method of claim 20, wherein forming said dielectric film via a polymer multilayer process comprises:
presenting a substrate;
placing said substrate in a vacuum chamber;
evacuating said vacuum chamber;
evaporating a monomer onto said substrate;
irradiating said evaporated monomer to form a first polymerized layer;
depositing a first dielectric layer on said first polymerized layer;
depositing said uncoated phosphor layer on said dielectric layer;
evaporating said monomer onto said uncoated phosphor layer;
irradiating said evaporated monomer to form a second polymerized layer; and
depositing a second dielectric layer on said first polymerized layer.

22. The method of claim 21, further comprising bombarding said substrate with plasma or ions prior to evaporating a monomer onto said substrate.

23. The method of claim 21, further comprising patterning an electrode on each of said first dielectric layer and said second dielectric layer.

24. The method of claim 23, wherein said patterned electrodes comprise optically transparent electrodes.

25. The method of claim 23, further comprising:
removing said electroluminescent display from said vacuum chamber; and
cutting said electroluminescent display to a desired size.

26. The method of claim 25, further comprising fitting each of said electrodes with an electrical connection hardware.

27. The method of claim 20, wherein said dielectric film is formed by said polymer multilayer process at approximately 1000 feed per minute.

28. The method of claim 21, wherein said step of depositing said uncoated phosphor layer on said dielectric layer comprises:
charging said dielectric layer: and
electrographically dispersing said uncoated phosphor layer onto said dielectric layer.

29. An electroluminescent display comprising:
a substrate;
a first means for conducting electricity;
a first means for reducing electrical conduction disposed on said first means for conducting electricity;
a means for generating light in response to electrical current disposed on said first means for reducing electrical conduction;
a second means for reducing electrical conduction disposed on top of said means for generating light; and
a second means for conducting electricity;
wherein said first means for reducing electrical conduction and said second means for reducing electrical conduction are formed by a polymer multilayer (PML) forming process.

30. The electroluminescent display of claim 29, wherein said first means for reducing electrical conduction comprises a pinhole free dielectric layer formed by a PML forming technique.

31. The electroluminescent display of claim 29, wherein said means for generating light in response to electrical current comprises a plurality of uncoated phosphor particles having a maximum diameter of less than approximately 30 microns.

32. The electroluminescent display of claim 29, wherein said first and said second means for conducting electricity comprise independently addressable electrodes.

33. The electroluminescent display of claim 29, further comprising:
a means for generating red light in response to electrical current disposed between a first plurality of means for reducing electrical conduction;
a means for generating green light in response to electrical current disposed between a second plurality of means for reducing electrical conduction;
a means for generating blue light in response to electrical current disposed between a third plurality of means for reducing electrical conduction; and
a plurality of independently addressable electrodes formed on each of said first plurality of means for reducing electrical conduction, said second plurality of means for reducing electrical conduction, and said third plurality of means for reducing electrical conduction;
wherein said means for generating red light in response to electrical current, said means for generating green light in response to electrical current, and said means for generating blue light in response to electrical current are vertically stacked to form a red/green/blue display.

34. The electroluminescent display of claim 29, wherein said substrate comprises a flexible substrate.

35. The electroluminescent display of claim 29, wherein said substrate comprises a rigid substrate.

36. A method for forming a vertically stacked RGB display comprising:
presenting a substrate;
forming a first electrode on said substrate;
depositing a first dielectric layer via PML deposition;
coating a layer of uncoated red electroluminescent phosphor on said first dielectric layer;
depositing a second dielectric layer onto said uncoated red electroluminescent phosphor via PML deposition;
forming a second electrode on said second dielectric layer;
depositing a third dielectric layer on said second electrode;
forming a third electrode on said third dielectric layer;
depositing a fourth dielectric layer onto said third electrode via PML deposition;
coating a layer of uncoated green electroluminescent phosphor on said fourth dielectric layer;
depositing a fifth dielectric layer onto said uncoated green electroluminescent phosphor via PML deposition;
forming a fourth electrode on said fifth dielectric layer;
depositing a sixth dielectric layer on said fourth electrode;
forming a fifth electrode on said sixth dielectric layer;
depositing a seventh dielectric layer onto said fifth electrode via PML deposition;
coating a layer of uncoated blue electroluminescent phosphor on said fifth dielectric layer; and
depositing an eighth dielectric layer onto said uncoated blue electroluminescent phosphor via PML deposition;
forming a sixth electrode on said eighth dielectric layer;
wherein said layer of uncoated red electroluminescent phosphor, said layer of green electroluminescent phosphor, and said layer of blue electroluminescent phosphor are vertically stacked to form a red/green/blue display.

37. The method of claim 36, wherein said first electrode, said second electrode, said third electrode, said fourth electrode, said fifth electrode, and said sixth electrode further comprise independently addressable electrodes.

38. The method of claim 37, wherein said first, said second, said third, said fourth, and said fifth independently addressable electrodes are optically transparent.

39. The method of claim 38, wherein said sixth independently addressable electrodes reflect visible light.

40. The method of claim 36, wherein said layer of uncoated red electroluminescent phosphor and said layer of uncoated green electroluminescent phosphor are patterned.
